(19) United States
(12) Patent Application Publication
(10) Pub. No.: US 2025/0330060 A1
(43) Pub. Date: Oct. 23, 2025

(54) MOTOR DRIVEN MECHANISM CAPABLE OF RECIPROCATING EXTENSION/RETRACTION AND VIBRATION

(71) Applicant: KERUI TECHNOLOGY (DONGGUAN) CO., LTD, Dongguan (CN)

(72) Inventors: Mu Yan, Dongguan (CN); Min Deng, Dongguan (CN); Zhihai Yang, Dongguan (CN)

(73) Assignee: KERUI TECHNOLOGY (DONGGUAN) CO., LTD, Dongguan (CN)

(21) Appl. No.: 18/823,753

(22) Filed: Sep. 4, 2024

Related U.S. Application Data
(63) Continuation of application No. PCT/CN2024/100448, filed on Jun. 20, 2024.

(30) Foreign Application Priority Data
Apr. 23, 2024 (CN) 202410490256.9

(51) Int. Cl. H02K 7/06; H02K 7/08; H02K 11/215

(52) U.S. Cl. CPC H02K 7/06; H02K 7/083; H02K 11/215; H02K 2205/03; H02K 2211/03

(57) ABSTRACT

The invention relates to the technical field of motors, and in particular to a motor driven mechanism capable of reciprocating extension/retraction and vibration, including an outer frame, a first connecting seat and a second connecting seat. The first connecting seat is provided with an extension/retraction driving component. The second connecting seat is provided with a rotary motor. The rotary motor includes a stator component and a driving shaft. A Hall sensor is arranged between the outer frame and the second connecting seat. The driving shaft is provided with an inductive magnetic ring. According to the invention, the extension/retraction driving component can drive the outer frame to move, and a guide rail drives the driving shaft to move synchronously, so that the driving shaft can extend and retract. Thus, the whole mechanism has a reciprocating extension/retraction function.

### CROSS-REFERENCE TO RELATED APPLICATIONS

The application claims priority to Chinese patent application No. 202410490256.9, filed on Apr. 23, 2024, the entire contents of which are incorporated herein by reference.

### TECHNICAL FIELD

The invention relates to the technical field of motors, and in particular to a motor driven mechanism capable of reciprocating extension/retraction and vibration.

### BACKGROUND

Motors are widely used in various field. A motor can not only make an object rotate, but also make an object move linearly, or make an object vibrate eccentrically in conjunction with an eccentric structure.

For an electric toothbrush, a motor is required to make it vibrate and rotate. In order to improve the brushing effect of the electric toothbrush, there are electric toothbrushes on the market that can vibrate as well as extend and retract. Nonetheless, such electric toothbrushes usually use a coil and a magnetic steel structure to drive the rotor to extend and retract, which, however, cannot provide enough extension and retraction for rotation, thereby affecting the brushing effect of the electric toothbrush.

### SUMMARY

An objective of the invention is to provide a motor driven mechanism capable of reciprocating extension/retraction and vibration to overcome the defects in the prior art.

The objective of the invention is realized by the following technical solutions: A motor driven mechanism capable of reciprocating extension/retraction and vibration includes an outer frame, a first connecting seat and a second connecting seat. A guide rail is arranged between the first connecting seat and the second connecting seat. The outer frame is slidably arranged on the guide rail.

The first connecting seat is provided with an extension/retraction driving component for driving the outer frame to slide. The second connecting seat is provided with a rotary motor.

The rotary motor includes a stator component and a driving shaft rotatably arranged in the stator component. The driving shaft is retractably and movably arranged in the stator component. One end of the driving shaft protrudes out of the second connecting seat and is rotatably connected to the outer frame.

One end of the driving shaft protrudes out of the second connecting seat and is provided with an inductive magnetic ring. A Hall sensor cooperating with the inductive magnetic ring is arranged between the outer frame and the second connecting seat.

Further, the extension/retraction driving component includes a direct-current motor, a screw and a swinging block. The direct-current motor is arranged at the first connecting seat. The screw is connected to an output of the direct-current motor. An outer wall of the screw is provided with a reciprocating spiral groove. The swinging block is movably arranged in the reciprocating spiral groove.

An end of the outer frame close to the first connecting seat is provided with an accommodating groove. The screw is retractably and movably arranged in the accommodating groove. The swinging block is rotatably arranged on an inner wall of the accommodating groove.

Further, an inner wall of the outer frame is provided with a clamping piece. The clamping piece is detachably connected to the outer frame. The swinging block is rotatably arranged at the clamping piece.

Further, an end of the outer frame close to the first connecting seat is provided with a rotating groove. One end of the driving shaft protrudes out of the second connecting seat and is rotatably arranged in the rotating groove. A thrust bearing is arranged between one end of the driving shaft and the rotating groove.

A bolt is arranged between one end of the driving shaft and the thrust bearing.

Further, the rotary motor further includes a housing. The housing is arranged at the second connecting seat.

The stator component includes a stator core arranged in the housing and a coil arranged around the stator core. The driving shaft is arranged in the stator core.

Further, a rotor core is sleeved outside the driving shaft. An outer wall of the rotor core is provided with a plurality of magnetic steels. The driving shaft, the rotor core and the magnetic steels are all rotatably arranged in the stator core. The driving shaft, the rotor core and the magnetic steels are all retractably and movably arranged in the stator core.

Further, the stator core is provided with an insulating frame. The insulating frame is arranged between the stator core and the rotor core.

Further, a first bearing is arranged between the driving shaft and one end of the housing. A second bearing is arranged between the driving shaft and the other end of the housing.

Further, an end of the outer frame close to the second connecting seat is provided with a circuit board. One end of the driving shaft runs through the circuit board. The Hall sensor is arranged at the circuit board.

The driving shaft is provided with a holder. The inductive magnetic ring is arranged at the holder.

Further, an end of the rotary motor close to the outer frame is provided with a circuit board. The Hall sensor is arranged at the circuit board. One end of the driving shaft runs through the circuit board. The driving shaft is provided with a holder. The inductive magnetic ring is movably arranged at the holder.

A piezoelectric ceramic sheet is arranged between the inductive magnetic ring and the holder.

The invention has the following beneficial effects:

1. According to the invention, the extension/retraction driving component can drive the outer frame to move along the guide rail, and the guide rail drives the driving shaft to move synchronously, so that the driving shaft can extend and retract on the rotary motor. Thus, the whole mechanism has a reciprocating extension/retraction function, thereby improving the efficiency.

2. Under the cooperation between the stator component and the driving shaft, the driving shaft can rotate in the housing of the rotary motor. Moreover, since the driving shaft is retractably and movably arranged in the stator component, the driving shaft generates vibration during rotation, so that the mechanism has a vibration function.

3. By controlling the driving shaft to extend and retract in the housing of the rotary motor, the loss of energy can be effectively reduced, and the noise can be effectively reduced.

4. According to the invention, the Hall sensor and the inductive magnetic ring can be arranged outside the rotary motor, so it is convenient to clean, repair and replace parts.

### BRIEF DESCRIPTION OF DRAWINGS

The invention will be further explained in conjunction with the accompanying drawings, but the embodiments in the accompanying drawings do not constitute any limitations on the invention. For those of ordinary skill in the art, other drawings can be obtained according to the accompanying drawings below without creative work.

FIG. 1 is a schematic structural view of Embodiment 1;

FIG. 2 is a sectional view of Embodiment 1;

FIG. 3 is a partial enlarged view of A in FIG. 2;

FIG. 4 is a schematic structural view of an extension/retraction driving component of the invention;

FIG. 5 is a sectional view of Embodiment 2;

FIG. 6 is a partial enlarged view of B in FIG. 5.

In the figures: 1, outer frame; 11, accommodating groove; 12, clamping piece; 13, rotating groove; 14, thrust bearing; 21, first connecting seat; 22, second connecting seat; 23, guide rail; 3, driving shaft; 31, bolt; 41, circuit board; 42, Hall sensor; 43, holder; 44, inductive magnetic ring; 51, direct-current motor; 52, screw; 53, swinging block; 54, reciprocating spiral groove; 6, housing; 61, stator core; 62, insulating frame; 71, rotor core; 72, magnetic steel; 81, first bearing; 82, second bearing; 9, piezoelectric ceramic sheet.

### DETAILED DESCRIPTION OF THE EMBODIMENTS

The invention will be further described below in conjunction with the embodiments.

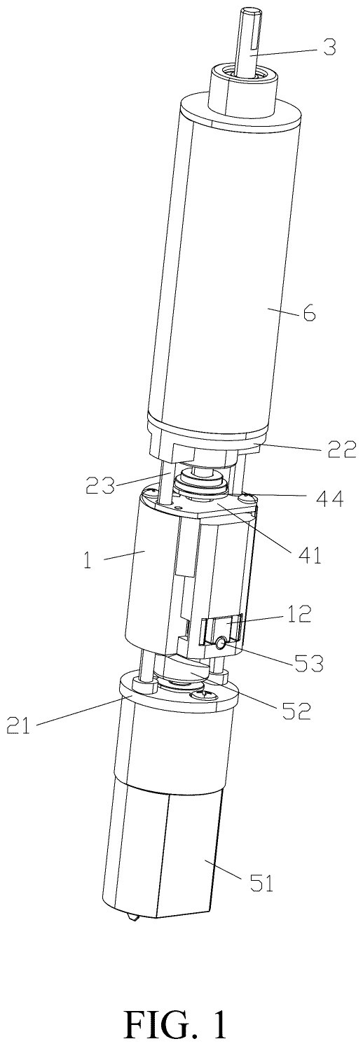

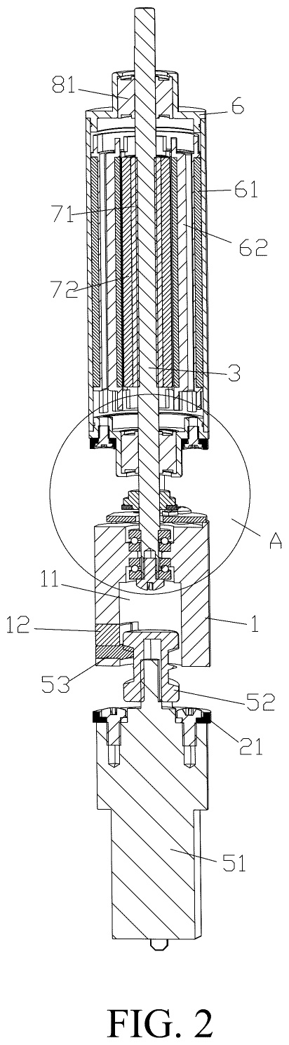

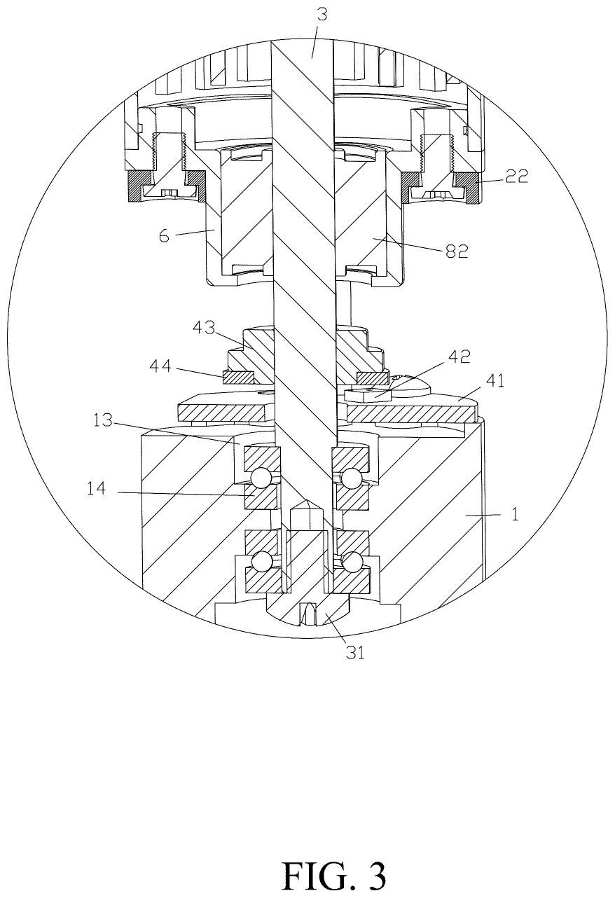

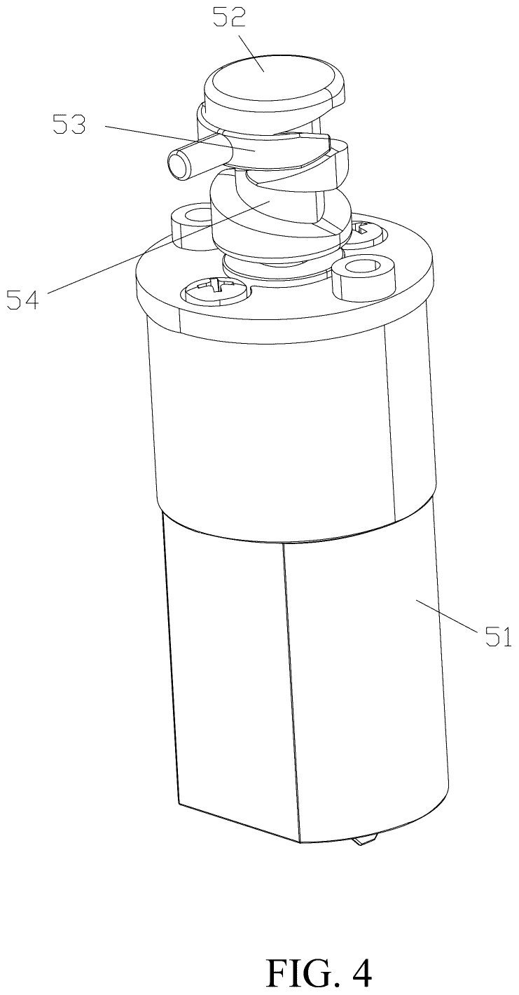

In Embodiment 1, as shown in FIG. 1 to FIG. 4, a motor driven mechanism capable of reciprocating extension/retraction and vibration in this embodiment includes an outer frame 1, a first connecting seat 21 and a second connecting seat 22. A guide rail 23 is arranged between the first connecting seat 21 and the second connecting seat 22. The outer frame 1 is slidably arranged on the guide rail 23.

The first connecting seat 21 is provided with an extension/retraction driving component for driving the outer frame 1 to slide. The second connecting seat 22 is provided with a rotary motor. The rotary motor may be a three-phase servo motor.

The rotary motor includes a stator component and a driving shaft 3 rotatably arranged in the stator component. The driving shaft 3 is retractably and movably arranged in the stator component. One end of the driving shaft 3 protrudes out of the second connecting seat 22 and is rotatably connected to the outer frame 1.

One end of the driving shaft 3 protrudes out of the second connecting seat 22 and is provided with an inductive magnetic ring 44. A Hall sensor 42 cooperating with the inductive magnetic ring 44 is arranged between the outer frame 1 and the second connecting seat 22.

Specifically, when the motor driven mechanism capable of reciprocating extension/retraction and vibration in this embodiment is in use, the extension/retraction driving component can drive the outer frame 1 to move along the guide rail 23, and the guide rail 23 drives the driving shaft 3 to move synchronously, so that the driving shaft 3 can extend and retract on the rotary motor. Moreover, the other end of the driving shaft 3 protrudes out of the housing 6 of the rotary motor and can be connected to a toothbrush head, so that the electric toothbrush can have a reciprocating extension/retraction function, thereby improving the efficiency of the electric toothbrush. In addition, under the cooperation between the stator component and the driving shaft 3, the driving shaft 3 can rotate in the housing 6 of the rotary motor. Moreover, since the driving shaft 3 is retractably and movably arranged in the stator component, the driving shaft 3 generates vibration during rotation, so that the electric toothbrush can have a vibration function. Besides, the extension/retraction driving component and the rotary motor can also work independently, so that the driving shaft 3 can extend/retract or rotate.

Secondly, according to this embodiment, by controlling the driving shaft 3 to extend and retract in the housing 6 of the rotary motor instead of driving the whole rotary motor to reciprocate, the loss of energy can be effectively reduced, and the noise can be effectively reduced.

Finally, based on the above, the Hall sensor 42 can be arranged between the outer frame 1 and the second connecting seat 22, and the inductive magnetic ring 44 can be arranged at a position of the driving shaft 3 protruding out of the second connecting seat 22, so that the vibration amplitude of the driving shaft 3 can be controlled under the cooperation between the Hall sensor 42 and the inductive magnetic ring 44. The traditional rotary motor, whose Hall sensor 42 and inductive magnetic ring 44 are arranged inside the rotary motor, has the problem of difficulty in cleaning, repair and replacement. In this embodiment, the Hall sensor 42 and the inductive magnetic ring 44 can be arranged outside the rotary motor, so it is convenient to clean, repair and replace parts.

According to the motor driven mechanism capable of reciprocating extension/retraction and vibration in this embodiment, the extension/retraction driving component includes a direct-current motor 51, a 52 and a swinging block 53. The direct-current motor 51 is arranged at the first connecting seat 21. The screw 52 is connected to an output of the direct-current motor 51. An outer wall of the screw 52 is provided with a reciprocating spiral groove 54. The swinging block 53 is movably arranged in the reciprocating spiral groove 54. The direct-current motor 51 may be a brush motor.

An end of the outer frame 1 close to the first connecting seat 21 is provided with an accommodating groove 11. The screw 52 is retractably and movably arranged in the accommodating groove 11. The swinging block 53 is rotatably arranged on an inner wall of the accommodating groove 11.

Specifically, with the above arrangement, when it is required to make the driving shaft 3 extend and retract, the direct-current motor 51 may be started, so that the direct-current motor 51 drives the screw 52 to rotate. Since the outer wall of the screw 52 is provided with the reciprocating spiral groove 54, the swinging block 53 is rotatably arranged in the outer frame 1 and the swinging block 53 moves in the reciprocating spiral groove 54, when the screw 52 rotates, the circular motion can be converted into the axial up-down extension and retraction motion of the outer frame 1, thereby driving the driving shaft 3 to extend and retract up and down. In addition, in order to make the whole structure stabler, a reducer may be arranged between the direct-current motor 51 and the screw 52, and the direct-current motor 51 drives the screw 52 to rotate after going through the reducer. In this embodiment, by arranging the direct-current motor 51 and the screw 52, the outer frame 1 can be pushed to move linearly, and the outer frame 1 drives the Hall sensor 42 and the driving shaft 3 to move linearly together, so that the motor driven mechanism capable of reciprocating extension/retraction and vibration has enough extension and retraction.

According to the motor driven mechanism capable of reciprocating extension/retraction and vibration in this embodiment, an inner wall of the outer frame 1 is provided with a clamping piece 12. The clamping piece 12 is detachably connected to the outer frame 1. The swinging block 53 is rotatably arranged at the clamping piece 12. With the above arrangement, it is convenient to repair and replace the swinging block 53.

According to the motor driven mechanism capable of reciprocating extension/retraction and vibration in this embodiment, an end of the outer frame 1 close to the first connecting seat 21 is provided with a rotating groove 13. One end of the driving shaft 3 protrudes out of the second connecting seat 22 and is rotatably arranged in the rotating groove 13. A thrust bearing 14 is arranged between one end of the driving shaft 3 and the rotating groove 13.

A bolt 31 is arranged between one end of the driving shaft 3 and the thrust bearing 14. By arranging the bolt 31, it is convenient to fix the driving shaft 3 with an inner ring of the thrust bearing 14.

Specifically, in this embodiment, the thrust bearing 14 is arranged. There may be two thrust bearings 14. The thrust bearings 14 on two sides can ensure the axial push and pull of the driving shaft 3 to be greater than or equal to 10 Kg.f. Moreover, the radial sweep vibration and the axial displacement of the driving shaft 3 can be separated without interference with each other. Besides, the whole structure is stabler and more reliable.

According to the motor driven mechanism capable of reciprocating extension/retraction and vibration in this embodiment, the rotary motor further includes a housing 6. The housing 6 is arranged at the second connecting seat 22. The stator component includes a stator core 61 arranged in the housing 6 and a coil arranged around the stator core 61. The driving shaft 3 is arranged in the stator core 61. According to the motor driven mechanism capable of reciprocating extension/retraction and vibration in this embodiment, a rotor core 71 is sleeved outside the driving shaft 3. An outer wall of the rotor core 71 is provided with a plurality of magnetic steels 72. The driving shaft 3, the rotor core 71 and the magnetic steels 72 are all rotatably arranged in the stator core 61. The driving shaft 3, the rotor core 71 and the magnetic steels 72 are all retractably and movably arranged in the stator core 61. The coil is not shown in the drawings.

Specifically, the stator core 61, the rotor core 71, the magnetic steels 72, the housing 6, the outer frame 1, the screw 52 and the direct-current motor 51 are all arranged with the driving shaft 3 as the axis, which makes the whole structure stable and reliable.

When it is required to make the driving shaft 3 vibrate or rotate, the coil may be energized to generate a magnetic field, which cooperates with the magnetic field of the magnetic steels 72 to make the driving shaft 3 rotate or vibrate.

According to the motor driven mechanism capable of reciprocating extension/retraction and vibration in this embodiment, the stator core 61 is provided with an insulating frame 62. The insulating frame 62 is arranged between the stator core 61 and the rotor core 71. Specifically, with the above arrangement, the insulating performance between the stator core 61 and the rotor core 71 can be ensured.

According to the motor driven mechanism capable of reciprocating extension/retraction and vibration in this embodiment, a first bearing 81 is arranged between the driving shaft 3 and one end of the housing 6. A second bearing 82 is arranged between the driving shaft 3 and the other end of the housing 6. Specifically, with the above arrangement, the driving shaft 3 can stably rotate between the first bearing 81 and the second bearing 82, and the driving shaft 3 can also stably extend and retract between the first bearing 81 and the second bearing 82.

According to the motor driven mechanism capable of reciprocating extension/retraction and vibration in this embodiment, an end of the outer frame 1 close to the second connecting seat 22 is provided with a circuit board 41. One end of the driving shaft 3 runs through the circuit board 41. The Hall sensor 42 is arranged at the circuit board 41. The driving shaft 3 is provided with a holder 43. The inductive magnetic ring 44 is arranged at the holder 43. The holder 43 is fixed to the driving shaft 3, so that the inductive magnetic ring 44 and the holder 43 can move along with the driving shaft 3. Moreover, the Hall sensor 42, the circuit board 41, the driving shaft 3, the holder 43 and the inductive magnetic ring 44 move synchronously, which can ensure a constant distance between the inductive magnetic ring 44 the Hall sensor 42, thereby ensuring the induction accuracy. Specifically, in this embodiment, with the above arrangement, the Hall sensor 42 and the inductive magnetic ring 44 can be arranged outside the rotary motor, so it is convenient to clean, repair and replace parts.

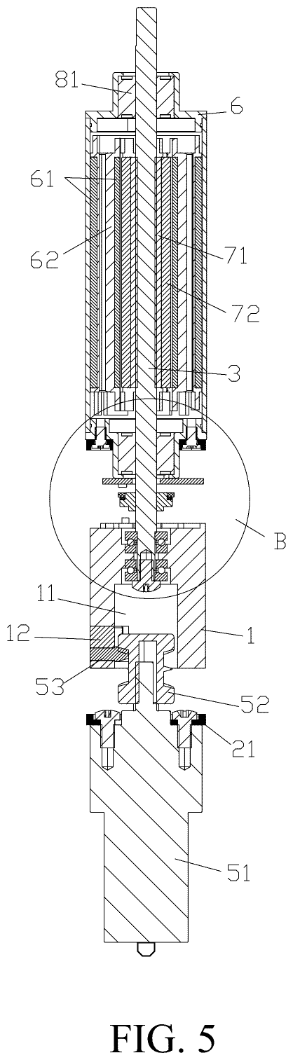

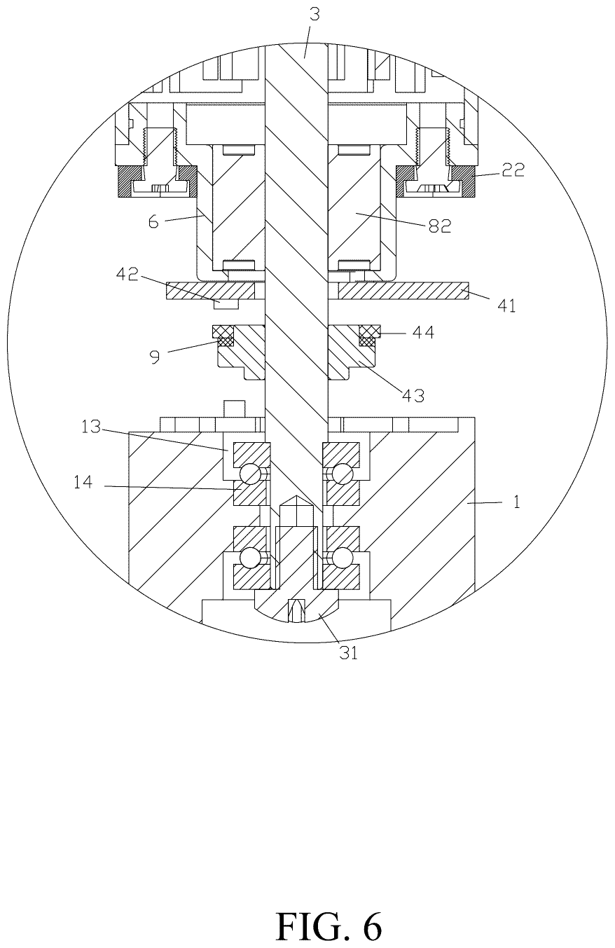

In Embodiment 2, as shown in FIG. 5 and FIG. 6, according to the motor driven mechanism capable of reciprocating extension/retraction and vibration in this embodiment, an end of the rotary motor close to the outer frame 1 is provided with a circuit board 41. The Hall sensor 42 is arranged at the circuit board 41. One end of the driving shaft 3 runs through the circuit board 41. The driving shaft 3 is provided with a holder 43. The inductive magnetic ring 44 is movably arranged at the holder 43.

A piezoelectric ceramic sheet 9 is arranged between the inductive magnetic ring 44 and the holder 43.

Specifically, this embodiment is different from Embodiment 1 in that the circuit board 41 is arranged on the housing 6 of the rotary motor. Since the Hall sensor 42 is a precision device, in Embodiment 1, the Hall sensor 42 continuously reciprocates along with the circuit and the outer frame 1, which easily leads to damage of the Hall sensor 42.

However, in this embodiment, the circuit board 41 and the Hall sensor 42 are fixed to the bottom of the housing 6 of the rotary motor, so that the Hall sensor 42 does not move any more, which effectively protects the Hall sensor 42. During the extension and retraction of the driving shaft 3, since the relative distance between the Hall sensor 42 and the magnetic ring changes, the piezoelectric ceramic sheet 9 is arranged between the inductive magnetic ring 44 and the holder 43, so that the piezoelectric ceramic sheet 9 can change its thickness according to the extension and retraction of the driving shaft 3, which ensures the relative distance between the Hall sensor 42 and the inductive magnetic ring 44 to be constant, thereby ensuring the stability of the system.

Finally, it should be noted that the above embodiments are only used to illustrate the technical solutions of the invention and are not intended to limit the protection scope of the invention. Although the invention has been described in detail with reference to the preferred embodiments, a person of ordinary skill in the art should understand that the technical solutions of the invention may be modified or equivalently substituted without departing from the spirit and scope of the technical solutions of the invention.

What is claimed is:

1. A motor driven mechanism capable of reciprocating extension/retraction and vibration, comprising an outer frame, a first connecting seat and a second connecting seat; wherein a guide rail is arranged between the first connecting seat and the second connecting seat; the outer frame is slidably arranged on the guide rail;
the first connecting seat is provided with an extension/retraction driving component for driving the outer frame to slide; the second connecting seat is provided with a rotary motor;
the rotary motor comprises a stator component and a driving shaft rotatably arranged in the stator component; the driving shaft is retractably and movably arranged in the stator component; one end of the driving shaft protrudes out of the second connecting seat and is rotatably connected to the outer frame;
one end of the driving shaft protrudes out of the second connecting seat and is provided with an inductive magnetic ring; and a Hall sensor cooperating with the inductive magnetic ring is arranged between the outer frame and the second connecting seat.

2. The motor driven mechanism capable of reciprocating extension/retraction and vibration according to claim 1, wherein the extension/retraction driving component comprises a direct-current motor, a screw and a swinging block; the direct-current motor is arranged at the first connecting seat; the screw is connected to an output of the direct-current motor; an outer wall of the screw is provided with a reciprocating spiral groove; the swinging block is movably arranged in the reciprocating spiral groove;
an end of the outer frame close to the first connecting seat is provided with an accommodating groove; and the screw is retractably and movably arranged in the accommodating groove; and the swinging block is rotatably arranged on an inner wall of the accommodating groove.

3. The motor driven mechanism capable of reciprocating extension/retraction and vibration according to claim 2, wherein an inner wall of the outer frame is provided with a clamping piece; the clamping piece is detachably connected to the outer frame; and the swinging block is rotatably arranged at the clamping piece.

4. The motor driven mechanism capable of reciprocating extension/retraction and vibration according to claim 1, wherein an end of the outer frame close to the first connecting seat is provided with a rotating groove; one end of the driving shaft protrudes out of the second connecting seat and is rotatably arranged in the rotating groove; a thrust bearing is arranged between one end of the driving shaft and the rotating groove; and
a bolt is arranged between one end of the driving shaft and the thrust bearing.

5. The motor driven mechanism capable of reciprocating extension/retraction and vibration according to claim 1, wherein the rotary motor further comprises a housing; the housing is arranged at the second connecting seat;
the stator component comprises a stator core arranged in the housing and a coil arranged around the stator core; and the driving shaft is arranged in the stator core.

6. The motor driven mechanism capable of reciprocating extension/retraction and vibration according to claim 5, wherein a rotor core is sleeved outside the driving shaft; an outer wall of the rotor core is provided with a plurality of magnetic steels; the driving shaft, the rotor core and the magnetic steels are all rotatably arranged in the stator core; and the driving shaft, the rotor core and the magnetic steels are all retractably and movably arranged in the stator core.

7. The motor driven mechanism capable of reciprocating extension/retraction and vibration according to claim 6, wherein the stator core is provided with an insulating frame; and the insulating frame is arranged between the stator core and the rotor core.

8. The motor driven mechanism capable of reciprocating extension/retraction and vibration according to claim 5, wherein a first bearing is arranged between the driving shaft and one end of the housing; and a second bearing is arranged between the driving shaft and the other end of the housing.

9. The motor driven mechanism capable of reciprocating extension/retraction and vibration according to claim 1, wherein an end of the outer frame close to the second connecting seat is provided with a circuit board; one end of the driving shaft runs through the circuit board; the Hall sensor is arranged at the circuit board;
the driving shaft is provided with a holder; and the inductive magnetic ring is arranged at the holder.

10. The motor driven mechanism capable of reciprocating extension/retraction and vibration according to claim 1, wherein an end of the rotary motor close to the outer frame is provided with a circuit board; the Hall sensor is arranged at the circuit board; one end of the driving shaft runs through the circuit board; the driving shaft is provided with a holder; the inductive magnetic ring is movably arranged at the holder; and
a piezoelectric ceramic sheet is arranged between the inductive magnetic ring and the holder.
